(19) United States
(12) Patent Application Publication
(10) Pub. No.: US 2004/0025461 A1
(43) Pub. Date: Feb. 12, 2004

(54) System for a free stall barn with a grooved floor, corresponding precast concrete slab and animal keeping method

(76) Inventor: Hermannus S.F. Reuver, Butzflethermoor (DE)

Correspondence Address: WILLIAM COLLARD, COLLARD & ROE, P.C., 1077 NORTHERN BOULEVARD, ROSLYN, NY, 11576, US

(21) Appl. No.: 10/398,864

(22) PCT Filed: Oct. 5, 2001
(86) PCT No.: PCT/DE01/03836

(30) Foreign Application Priority Data
Oct. 13, 2000 (DE) 100 50 853.7
Jul. 25, 2001 (DE) 201 12 280.4

(51) Int. Cl. E04B 1/70; E04F 17/00; E04F 17/04; E04F 17/08; A01K 1/01

(52) U.S. Cl. 52/302.1; 119/450

(57) ABSTRACT

The invention relates to a system for a free stall barn or the like for keeping animals, especially cattle, comprising a grooved floor configured as a concrete slab. Said grooved floor has a floor surface and said floor surface, between adjacent grooves, is provided with an elastic and anti-slip covering that reaches close to the grooves. The invention further relates to a precast concrete slab for assembling such a system wherein the precast concrete slab corresponds to the floor width and, in the longitudinal direction, is provided with adjusting elements for exactly aligning the slabs to be joined. The invention further relates to a method for keeping animals in the inventive system, according to which an organic or mineral binder is strewed across the floor of the free stall barn and the bound solid manure and liquid manure is separated when the barn is cleaned out.

The invention relates to an arrangement for a cubicle barn or the like for keeping livestock, in particular for cattle, having a grooved floor which is designed as a concrete slab, to a precast concrete slab for this arrangement, and to a method of keeping livestock in such an arrangement.

For the intensive keeping of livestock, in particular cattle, cubicle barns provide a good compromise for economical, intensive livestock keeping with sufficient freedom of movement for the livestock. In this case, in addition to the respectively assigned cubicles, the livestock are provided with a walkway passage, on which the livestock can move freely.

For the straightforward disposal of the animals' urine and feces along this walkway passage, the prior art has dispensed with the scattering of straw and provided a slatted floor with a semi-liquid-manure pit arranged therebeneath. Such slatted floors are described, for example, in EP 0 609 581 A1 and DE 299 07 118 U1. These two documents also propose providing an asphalt or bitumen layer as a walking surface for the livestock. In this case, the slatted-floor elements are formed, for example, in one piece such that projecting edges form for edge reinforcement at the gap borders for the bitumen covering.

The disadvantage here, however, is that the livestock are constantly exposed to the gases escaping from the semi-liquid manure collected beneath the slatted floor. It is thus known for cubicle barns to be equipped with walkway passages designed as floors with grooves or channels.

The grooved floor is produced as a concrete floor or precast concrete unit with channel-form grooves and essentially closes off the semi-liquid-manure pit located therebeneath. The semi-liquid manure reaches the pit located therebeneath via through-passage bores arranged in the grooves. The gases correspondingly pose less of a problem.

The 2000/2001 price list from Brouwers Stalinrichtingen B. V., 8901 B A Leeuwarden, Holland, page 74, discloses a grooved floor of the generic type which has a reciprocating slide with a hard-rubber block for cleaning the floor surfaces and grooves.

Furthermore, mats which can be laid on the underlying surface, for example as found in the “UBO” catalog from M. Glöggler, Neu-Ulm/Schwaighofen, have been known since Jun. 25, 1981 at the German Patent and Trademark Office and are disclosed in DE 26 10 954 A1. These mats consist of essentially homogenous rubber material which, on account of the elastic and heat-insulating properties, is intended to increase, in particular, the lying comfort for the livestock.

The disadvantage with the current prior art mentioned above is that the animals' feces and urine is present in a mixed-together and non-bound state as so-called semi-liquid manure. The handling-related advantages of the now usually used semi-liquid-manure system in comparison with the earlier operation of manual straw scattering and mucking come at the price of the considerably more aggressive properties of the semi-liquid manure. The development of gases in semi-liquid-manure pits gives rise to a health hazard for people and animals and to a considerable risk of accidents for the operatives carrying out maintenance or repair work on semi-liquid-manure pits. The intermixing of the semi-liquid manure in the semi-liquid-manure pit before the semi-liquid manure is extracted results in the harmful gases being released to a particularly pronounced extent and increases the health hazards. When using semi-liquid manure for fertilization, the “hydrogen-cyanide gas” produced in the semi-liquid manure is toxic to the soil life, with the result that the soil life is rendered inactive and/or reduced and the soil quality is thus impaired, which results in a reduction in yield. Furthermore, flushing out scarcely bound nitrates has a considerable adverse effect on the groundwater.

It is also disadvantageous that the level of comfort for the livestock is lower in comparison with barns scattered with straw. The concrete floor is very hard and cold for the animals. Furthermore, there is a risk of the livestock being injured by slipping on the relatively smooth concrete surface.

Taking the grooved floor of the generic type as departure point, the object of the invention is to specify an improved arrangement for a cubicle barn and an improved method of keeping livestock for such an arrangement, in the case of which, along with straightforward handling, the level of comfort for the livestock is improved and the presence of semi-liquid manure is avoided.

This object is achieved by the features of claim 1 and the features of claim 22.

Since the floor surface, between adjacent grooves, is provided with an elastic and anti-slip covering, which extends into the vicinity of the grooves, the level of comfort of the surface on which the animals tread is improved. The elastic and anti-slip covering also prevents the animals from slipping on the surface.

Undesired shearing off of the covering at the groove border is avoided by the covering terminating before the groove border.

Since the grooves in the floor are defined by stable U-profiles, essentially wear-free groove flanks are formed. The groove width may thus be adapted optimally to the livestock using the grooved floor, since the U-profile prevents the groove flanks from breaking and consequently prevents the animals from sustaining injuries in the foot region.

The U-profiles are preferably produced from fracture-resistant rigid plastic or metal, in particular steel. Plastic profiles are indeed essentially rotproof, but tend to wear to a somewhat greater extent at their top edge, whereas steel U-profiles do start to rust quickly in the acid environment, but wear to a lesser extent at the top edge.

For the production of the grooved floor, up to ⅓to ⅚ of the leg height of the U-profile is concreted into the concrete floor, whereas the rest of the vertical extent between adjacent U-profiles is filled with the covering. The U-profile is thus anchored firmly in the concrete slab. When the grooved-floor surface is reconstructed once it has reached the limit of its useful life, the covering remaining on the surface is removed and the U-profiles are removed from the concrete slab by levering out and/or by burning. New U-profiles are then anchored in the existing concrete channels using suitable fastening means and a new surface covering is applied between adjacent U-profiles.

The U-profile has a leg height of from 2 to 20 cm, preferably approximately 10 cm, and forms a groove width of from 3 to 4 cm, preferably 3.5 cm. In the preferred configuration, the U-profile penetrates approximately 7 cm into the concrete floor, with the result that the surface covering is approximately 3 cm thick.

In order to facilitate an equally spaced-apart, dimensionally accurate construction of the grooves defined by the U-profiles, the parallel U-profiles are connected at their base at the desired spacing by a connecting element, preferably by means of flat iron bars welded therebeneath. In addition to the U-profiles being partially set in concrete according to claim 5, it is possible to fasten these prefabricated U-profile grids, in particular in the case of the U-profiles having a low leg height of only a few centimeters, directly on a planar concrete floor, for example by means of fastener holes and screws, and to fill the interspaces exclusively with the covering. Although, in the case of this arrangement, the groove flanks are permanently defined by the stable U-profile legs, preferably steel profiles, and the risk of injury to the livestock is avoided by the avoidance of worn flanks, the grooved floor nevertheless entails considerable production outlay.

Since the grooves are defined in full by the concrete of the concrete slab, the time-consuming production method using separately introduced steel U-profiles is not necessary. The concrete slab can be produced in one casting operation. In order, nevertheless, to ensure the considerable improvement in comfort for the livestock by providing an elastic and anti-slip covering, the floor region between adjacent grooves is of sunken configuration in order to accommodate an elastic and anti-slip covering. The concrete projecting portions provided directly adjacent to the grooves here form, as it were, the mold for the elastic covering which is to be introduced.

Since the accommodating depression of the concrete slab between adjacent grooves has a rectangular or hemiellipsoidal cross section in the cross-sectional direction in relation to the grooves, this ensures a material thickness for the elastic covering which is suitable in respect of comfort improvement and wear resistance, the groove-enclosing concrete groove-border region being of sufficiently stable design.

Since the concrete border region for the grooves on the surface on both sides of the groove, which is approximately 3 cm wide, has a width of in each case 2 cm and the sunken formation of the concrete surface is approximately 2 cm on average, a sufficiently stable concrete groove-border region is provided, the asphalt layer provided for improving comfort forming a very large part of the surface.

Since the concrete groove-border region is reinforced by a reinforcing element, preferably a reinforcing steel member, there is an increase in the strength of the concrete border region alongside the grooves, and the situation where the concrete edge may possibly break off is thus avoided to the greatest extent. The reinforcing element may consist, for example, of a reinforcing steel member cast in the concrete in the border region or of a steel reinforcing profile which extends up to the surface.

The elastic covering is preferably formed from a bituminous substance, preferably asphalt, or an elastomer. Asphalt is a sufficiently elastic and anti-slip surface covering which, in particular, is also resistant to the effects of urine and feces. Furthermore, asphalt is a cost-effective material which is easy to process. Alternatively, the surface may also be formed from an acid-resistant elastomer which, albeit at a higher cost, can also provide a further improvement in comfort.

The U-profiles are arranged parallel in the longitudinal direction of the grooved floor and have a center-to-center spacing from one another of from 16-50 cm, preferably 25 cm. This provides a sufficient liquid-accommodating capacity for the grooves while, at the same time, giving the widest possible standing surfaces for the livestock.

Since a liquid-manure pit with a slatted floor for accommodating the liquids collected in the grooves is arranged at at least one head end of the grooved floor, the liquid not taken up by the straw and, if appropriate, sand is intercepted in an effective manner. For cleaning purposes, the liquid-manure pit arranged at at least one head end of the grooved floor may be cleaned by the removal of the slats of the slatted floor without the livestock keeping being seriously influenced, this being done, for example, for dredging solids which have been washed along in the liquid manure. During normal operation, the slatted floor serves as a connecting passage between parallel grooved floors.

If a mucking system with a slide which can be moved in the longitudinal direction of the grooves is arranged on the grooved floor, automatic mucking of the grooved floor is made possible. Preferably in conjunction with the liquid-manure pit with slatted base, arranged at one head end of the grooved floor, the solid constituents, namely the solid manure, is conveyed out of the cubicle barn to an interim manure store via gates which adjoin in the longitudinal direction. The liquid manure passes into the liquid-manure pit via the gaps in the slatted floor.

In order to achieve particularly effective cleaning of the grooved floor using the mucking system, the slide has tine-like extensions which correspond to the groove arrangement and engage in the grooves during operation.

Since the grooved floor is formed from precast concrete slabs, the grooved floor can be constructed quickly on site, using precast concrete units which are to be joined to one another, without long drying periods for the concrete having to be taken into account. Precast concrete units can be industrially produced cost-effectively with high dimensional accuracy.

For retrofitting conventional cubicle barns which are provided with a semi-liquid-manure reservoir beneath the walkway passage designed as a slatted floor, the precast concrete slabs may be laid on the border of the semi-liquid-manure pit as replacement elements for the slats of the slatted floor. Through-passage bores arranged in the grooves allow liquid to pass through from the grooved floor into the former semi-liquid-manure pit.

The precast concrete slab for constructing an arrangement according to the invention preferably corresponds to the floor width and has fitting elements in the longitudinal direction for the accurately fitting alignment of the slabs which are to be joined to one another. By means of the fitting elements, the grooves of the precast units which are to be joined to one another are aligned in the longitudinal direction, with the result that a mucking slide provided with tines engaging in the grooves does not catch on the transition locations between slabs.

The fitting elements preferably comprise protrusions arranged on one end side of the slab and associated sockets arranged on the other end side of the slab.

Since essentially equally spaced-apart grooves are provided over the floor width, a relatively wide central concrete part being provided in the center and in each case one side strip without accommodating depressions for an elastic covering being provided at the border, a preferred floor configuration is one in which a somewhat wider concrete surface is provided in the center and a narrower concrete surface for bearing a reciprocating mucking slide is provided at the sides.

A considerable improvement in comfort for the livestock is achieved by an organic or mineral binder, for example straw, shredded straw, wood shavings and/or sand, being scattered in the cubicle barn. In keeping with age-old tradition, the bedding scattered binds the feces to form solid manure. The liquid constituents are collected in the grooves and led to the liquid-manure pit. A known automatic mucking system, in particular according to claims 15 and 16, is used in order for the solid manure resting in the grooved floor to be conveyed out of the barn to a collecting location.

Since solid manure is a higher-grade fertilizer with better nitrate binding than semi-liquid manure, this separation is likewise advantageous for ecological reasons. Furthermore, the liquid manure collected in the pit is less aggressive than the semi-liquid manure. The risks described in the introduction to which the operatives are exposed are considerably fewer in liquid-manure pits.

In order to reduce the susceptibility to malfunctioning during automatic mucking and to make it possible for the solid manure collected to be used immediately as fertilizer, it is possible for the straw to be distributed in finely cut form in the cubicle barn.

Additionally scattering wood shavings (bedding) and/or sand in the cubicle barn makes it possible to achieve a further improvement in the operation of binding the liquid and feces. Adding these organic or mineral constituents further increases the quality of the solid manure.

Various exemplary embodiments of the invention are explained in detail hereinbelow with reference to the drawings, in which:

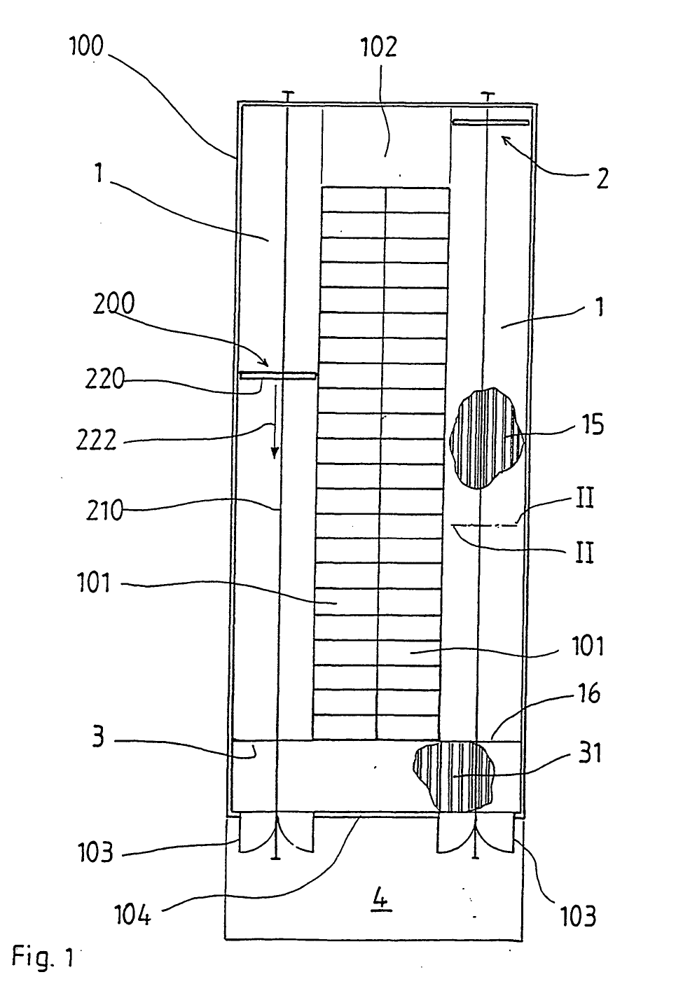

FIG. 1 shows a plan view of a cubicle barn with a grooved floor,

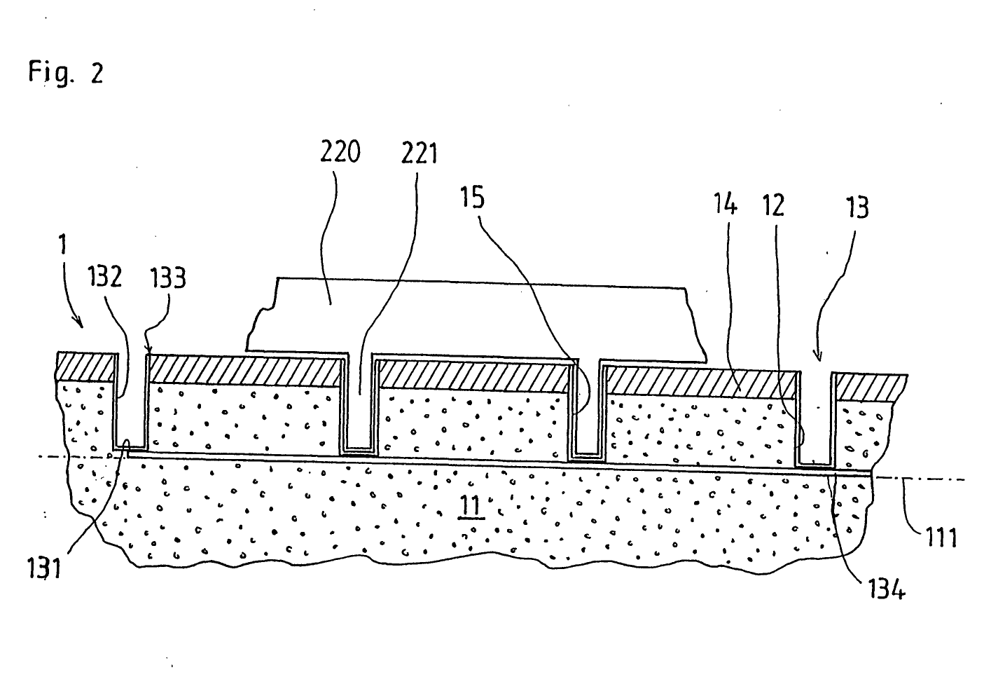

FIG. 2 shows, in cross section, a detail of the grooved floor along line II-II illustrated by dashed lines in FIG. 1,

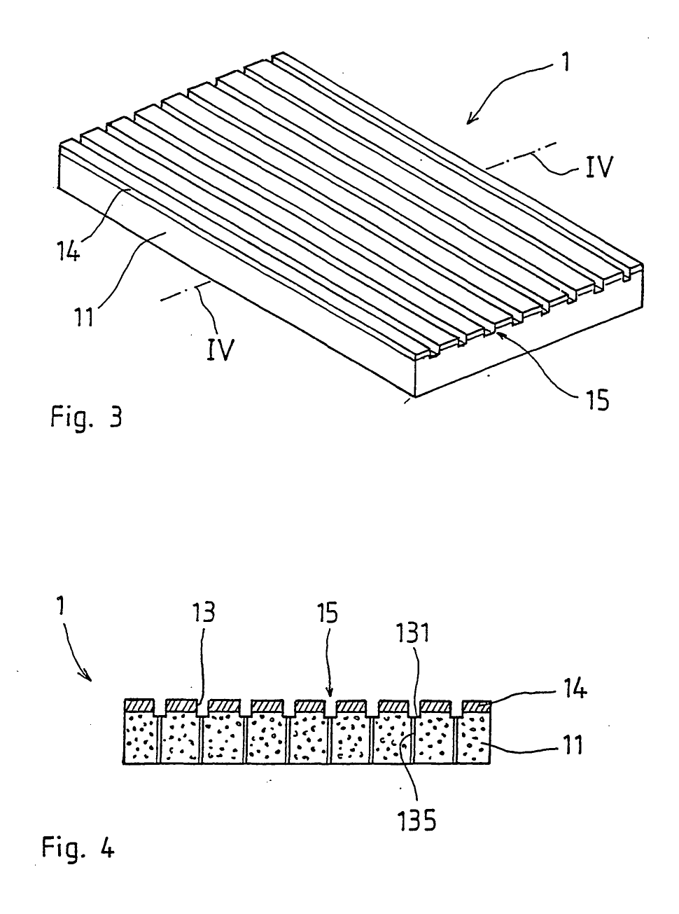

FIG. 3 shows a three-dimensional view of a grooved-floor concrete slab as a precast unit,

FIG. 4 shows a cross section through the concrete slab of FIG. 3 along the dashed line IV-IV,

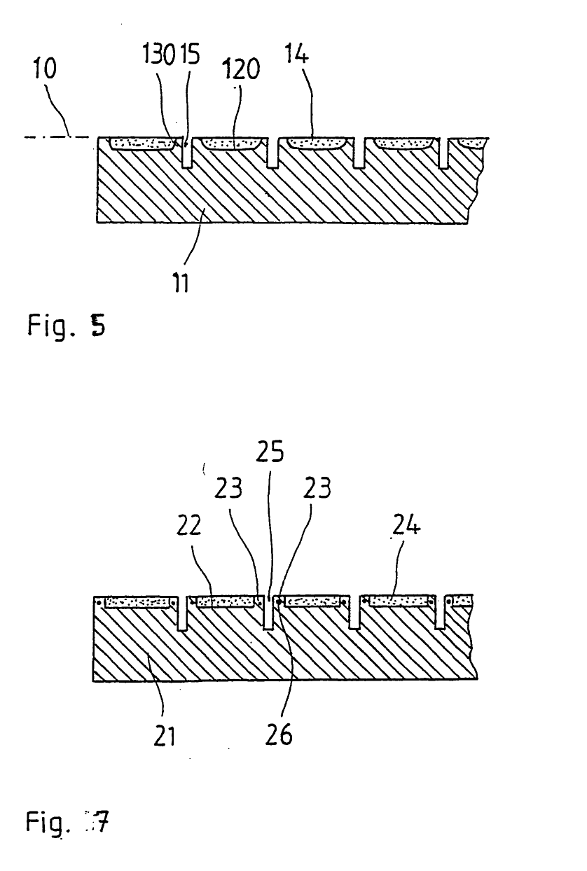

FIG. 5 shows a cross section, in detail form, along the end surface of a precast concrete slab according to the invention,

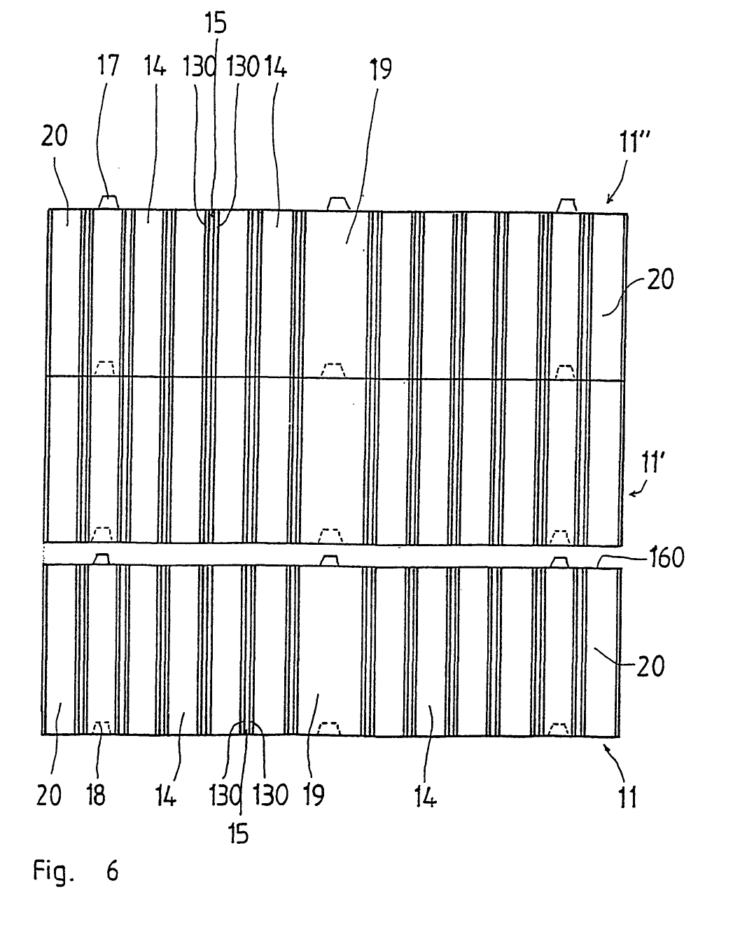

FIG. 6 shows a plan view of three precast concrete slabs, two of which have been joined to one another and one of which is to be joined, in the embodiment according to FIG. 5, and

FIG. 7 shows a cross section of an alternative embodiment of the grooved-floor concrete slab.

FIG. 1 is a schematic illustration of the plan view of a cubicle barn 100. In the exemplary embodiment illustrated, the rectangular barn 100 has a double row of cubicles 101 arranged in the center of the barn 100. Each cubicle 101 provides space for one cow. In each case one walkway floor 1, which is designed as a grooved floor with grooves 15, is provided on both sides of the rows of cubicles, along the longitudinal extent of the barn 100, FIG. 1, for the sake of clarity, only illustrating one cut-away surface area with grooves.

At that end of the barn which is at the top of the drawing, the two grooved floors 1, 1 are connected by a walkway passage 102. At that end of the rows of cubicles which is illustrated at the bottom of the drawing, the head end 16 of the two grooved floors 1, 1 is adjoined by a liquid-manure pit 3 covered by a slatted floor 31, which, for the sake of clarity, is only illustrated in one cut-away surface area in FIG. 1. The slatted floor 31 on the liquid-manure pit 3 is arranged such that the gaps in the slatted floor 31 are aligned in extension of the grooves 15 of the grooved floors 1, 1. In extension of the grooved floors 1, 1, gates 103, 103 are provided in the end wall 104 of the barn assigned to the liquid-manure pit 3.

Installed on each grooved floor 1 is a mucking system 200 which has a slide 220 which covers over the width of the grooved floor and has tines 221 associated with the grooved-floor geometry (see FIG. 2). A drive unit (not illustrated) is used to move the slide 220 back and forth, as required, in the longitudinal direction of the grooved floor 1 by way of pulling or pushing elements 210.

In the exemplary embodiment illustrated, the slide 220 only operates upon movement in the arrow direction 222. In this case, the solid manure taken up by the slide 220 is pushed along the grooved floor 1, via the slatted floor 31 and through the open gate 103, into an interim manure store 4 arranged outside the cubicle barn 100. During mucking using the slide 220, the liquid collected in the grooves 15 is likewise transported in the direction of the slatted floor 31 by the tines 221. In this case, the liquid manure essentially flows through the slatted floor 31 into the liquid-manure pit 3 located therebeneath. Correspondingly, the gaps in the slatted floor 31 are aligned with the grooves of the grooved floors 1, 1. In order to make it possible for the slide 220, which is equipped with tines 221 engaging in the grooves 15 to pass through freely beyond the slatted floor 31, the spacers integrally formed on the slats of the slatted floor are recessed on the top side.

FIG. 2 shows, in cross section, a detail of a grooved floor 1 with a slide 220 sliding above the latter, and likewise shown in detail form. The grooved floor 1 comprises a load-bearing structure 11 made of concrete, which, in the first instance, is poured up to the chain-dotted line 111 to form a planar surface. The grooves 15 of the grooved floor 1 are formed by U-profiles 13, for example steel profiles. The U-profiles 13 have their base 131 located on the pouring level 111. The legs 132 of the U-profiles 13 project upward and form the groove 15 which is to be kept free. The interspace is then partially filled with concrete, a top section being filled with an anti-slip and elastic covering 14. This covering 14, together with the top edges 133 of the legs 132 of the U-profiles 13, forms the walkway surface of the grooved floor 1. For easier installation, the U-profiles 13 are retained parallel to one another, and at equal spacings, by means of connecting elements 134, for example made of flat iron bars.

In the exemplary embodiment illustrated, the steel U-profiles 13 have the dimensions 100×40×3, and are welded to flat iron bars 134 with the dimensions 60×8, as a result of which the grooves 15 defined by the U-profile 13 have an inside width of 34 mm.

These prefabricated U-profile grids are laid on the poured load-bearing structure (pouring level 111), aligned and welded to one another in the longitudinal direction and then set in concrete up to a height of 7 cm. The rest of the vertical extent between adjacent U-profiles of 3 cm is filled with asphalt cement as surface covering 14.

FIGS. 3 and 4 show a further exemplary embodiment for the grooved floor 1, in the case of which the load-bearing structure 11 is prefabricated as a precast concrete unit of standard dimensions. FIG. 3 shows a three-dimensional view of a precast concrete unit for covering conventional semi-liquid-manure pits as a replacement element for the conventional slats for slatted floors.

As is illustrated in cross section in FIG. 4, the U-profiles 13 in this exemplary embodiment merely have a leg height of 40 mm in order to ensure, in the case of an overall thickness of the floor slab of 20 cm, sufficient load-bearing capability of the slab which is weakened by the accommodating grooves for the U-profiles. In this case, the U-profiles 13 are only set in the concrete to a depth of approximately 1 cm, with the result that a thickness of approximately 3 cm remains for the asphalt covering 14.

In contrast to the abovementioned exemplary embodiment, in this case drainage bores 135 are provided in the base 131 of the U-profiles 13, and extend through the concrete slab, in order for the liquid manure collected in the grooves to be led away into the pit located therebeneath.

This exemplary embodiment makes it possible for a conventional cubicle barn with a reservoirs for collecting semi-liquid manure beneath a slatted floor to be converted into an arrangement according to the invention without high outlay being involved. The slats of the slatted floor are lifted and replaced by the precast concrete slabs containing groove profiles.

In a further embodiment, the grooves are defined in full by the concrete of the concrete slab. FIG. 5 shows an end view, in detail form, of a precast concrete slab 11 in which a plurality of parallel grooves 15 are formed. Between adjacent grooves 15, the concrete slab has an accommodating depression 120 which extends more or less as far as the grooves. In the end view illustrated in FIG. 5, the accommodating depression 120 has a shallow hemiellipsoidal cross section.

The grooves 15 are formed with narrow concrete border regions 130 which extend up to the walkway-floor surface 10. As a result of the hemiellipsoidal cross section of the accommodating depression 120, the concrete border region in the structure of the concrete slab 11 tapers continuously to the surface 10. The concrete border regions 130 are correspondingly stable under loading.

FIG. 6 illustrates a plan view of three precast concrete slabs 11, 11′ and 11″, two of which have been joined to one another and one of which is to be joined. The precast concrete slabs 11, 11′, 11″ correspond to the exemplary illustrated in FIG. 5. The precast concrete slabs have the width of the grooved floor which is to be produced and have a standard length, with the result that the individual grooved-floor concrete slab is still easy to handle and transport as a precast unit. The floor length required for the barn which is to be fitted out is formed by joining a corresponding number of precast concrete slabs to one another in the longitudinal direction.

In order to ensure accurately fitting alignment of the slabs which are to be joined to one another, fitting elements 17 and 18 are alternately formed on the end sides 160 of the precast concrete slabs 11, 11′, 11″. In the exemplary embodiment illustrated, the fitting elements comprise protrusions 17 arranged on one end side of the slab and sockets 18 aligned therewith on the other end side.

FIG. 6 illustrates the precast concrete slabs 11′ and 11″ in the already joined-together state. The fitting elements, which are no longer visible on the surface, are illustrated by dashed lines at the joining edge. Furthermore, the precast concrete slab 11 is illustrated before being joined to the precast concrete slab 11′. Correspondingly, it is possible to see the protrusions 17 on the end side 160 of the precast concrete slab 11. Sockets 18 provided for the protrusions 17 are represented by dashed lines in the associated end side 160 of the precast concrete slab 11′.

A preferred groove division can also be seen in plan view in FIG. 6. The grooved floor has a total of twelve grooves 15, which are each arranged as six equally spaced-apart grooves on both sides of a central concrete part 19. The central part 19 serves as a stable bearing means for the mucking slide, which can be moved back and forth by a push rod. Furthermore, in each case one side strip 20 is formed on the outside, this likewise merely having a concrete surface, that is to say no accommodating depression for asphalt.

FIG. 7 illustrates a cross section, in detail form, of an alternative embodiment of a grooved-floor concrete slab 21. The precast concrete slab 21, in the same way as the previous exemplary embodiment, has an accommodating depression 22 between adjacent grooves 25. However, the accommodating depression 22 has a rectangular cross section. This accommodating depression 22 is likewise filled with an asphalt covering 24.

On account of the rectangular accommodating depression 22, the concrete border region 23 has vertical flanks on both sides. A reinforcing steel member 26 is cast in the concrete in order to reinforce the border region 23.

It is particularly important for the cubicle-barn arrangement according to the invention to be used with a bedding of straw and for straw manure and liquid manure to be separated during mucking.

As is known from age-old livestock-keeping traditions, straw helps to bind the animals' feces and increases the well-being of the animals. The arrangement according to the invention easily achieves the situation where liquid manure and solid manure can be discharged in an automated manner by conventional slide systems, the arrangement allowing the liquid and solid constituents to be separated to the greatest extent. The straw manure is an ideal soil fertilizer in particular for agricultural land. The organically high-grade and non-toxic fertilization using the straw manure produced in accordance with the arrangement and method activates the soil life of the fertilized pasture and/or tilled land. The soil becomes more fertile.

In addition to using straw as bedding, it is also possible to use wood shavings and/or sand, which, as organic or mineral constituents, further increase the quality of the manure and additionally allow the buffer-storage of moisture.

In addition to providing improved animal health, the arrangement according to the invention and the associated livestock-keeping method are used to produce an organically high-grade soil fertilizer which results in permanently more productive soils. The yield harvested from the land is much easier to balance against the amount of fertilizer used. There is both an ecological advantage and an economic advantage in using the invention in agriculture. The invention may also be advantageously utilized by extensive, ecological or so-called “bio” farms.

List of designations

| | |
|---|---|
| 1 | Grooved floor, walkway floor |
| 10 | Walkway-floor surface |
| 100 | Cubicle barn |
| 101 | Cubicle |
| 102 | Walkway passage |
| 103 | Gate |
| 104 | End wall of barn |
| 11 | Load-bearing structure, concrete slab |
| 111 | Pouring level |
| 12 | Channel |
| 120 | Accommodating depression |
| 13 | U-profile |
| 130 | Concrete border region |
| 131 | Base |
| 132 | Leg |
| 133 | Top edge |
| 134 | Connecting element, flat iron bar |
| 135 | Drainage bore |
| 14 | (Asphalt) covering |
| 15 | Groove |
| 16 | Head end |
| 160 | End side |
| 17 | Protrusion, fitting element |
| 18 | Socket, fitting element |
| 19 | Central concrete part |
| 20 | Side strip |
| 21 | Precast concrete slab |
| 22 | Accommodating depression |
| 23 | Concrete border region |
| 24 | Asphalt covering |
| 25 | Groove |
| 26 | Reinforcing steel member |
| 200 | Mucking system |
| 210 | Pulling or pushing element |
| 220 | Slide |
| 221 | Tine, extension |
| 222 | Movement direction |
| 3 | Liquid-manure pit |
| 31 | Slatted floor |
| 4 | Interim manure store |

1. An arrangement for a cubicle barn or the like for keeping livestock, in particular cattle, having a grooved floor (1) which is designed as a concrete slab (11) and has a floor surface (10), characterized in that the floor surface (10), between adjacent grooves (15), is provided with an elastic and anti-slip covering (14), which extends into the vicinity of the grooves.

2. The arrangement as claimed in claim 1, characterized in that the grooves (15) in the floor (1) are defined by stable U-profiles (13) and the floor surface, between adjacent U-profiles (13), are provided with the elastic and anti-slip covering (14).

3. The arrangement as claimed in claim 2, characterized in that the U-profiles (13) are formed from fracture-resistant rigid plastic or metal, preferably steel.

4. The arrangement as claimed in claim 2 or 3, characterized in that, on its top side, the concrete slab (11) has accommodating channels (12) for the U-profiles (13).

5. The arrangement as claimed in claim 2, 3 or 4, characterized in that up to ⅓ to ⅚ of the leg height of the U-profile (13) penetrates into the concrete slab (11) and the rest of the vertical extent between adjacent U-profiles (13) is filled with the covering (14).

6. The arrangement as claimed in claim 2, 3, 4 or 5, characterized in that the U-profile (13) has legs (132) with a height of from 2-20 cm, preferably approximately 10 cm, and, with the base (131), defines a groove width of from 3-4 cm, preferably 3.5 cm.

7. The arrangement as claimed in one of claims 2 to 6, characterized in that the parallel U-profiles (13) are connected at their base (131) at the desired spacing by a connecting element (134), preferably by means of flat iron bars welded therebeneath.

8. The arrangement as claimed in claim 1, characterized in that the grooves (15) are defined in full by the concrete of the concrete slab (11), the concrete slab (11), between adjacent grooves (15), having an accommodating depression (120) which extends more or less as far as the grooves (15) and is filled with the elastic and anti-slip covering (14) to form a planar surface.

9. The arrangement as claimed in claim 8, characterized in that the accommodating depression (120) of the concrete slab (11) between adjacent grooves (15) has a rectangular or hemiellipsoidal cross section in the cross-sectional direction in relation to the grooves (15).

10. The arrangement as claimed in claim 8 or 9, characterized in that a concrete border region (130) for the grooves (15) on the surface (10) on both sides of the groove (15), which is approximately 3 cm wide, has a width of in each case 2 cm and the sunken formation of the concrete surface (accommodating depression (120)) is approximately 2 cm on average.

11. The arrangement as claimed in claim 10, characterized in that the concrete groove-border region (130) is reinforced by a reinforcing element, preferably a reinforcing steel member (26).

12. The arrangement as claimed in one of the preceding claims, characterized in that the elastic covering (14) is formed from a bituminous substance, preferably asphalt, or an elastomer.

13. The arrangement as claimed in one of the preceding claims, characterized in that the grooves (15) are arranged parallel in the longitudinal direction of the grooved floor (1) and have a center-to-center spacing from one another of 16-50 cm, preferably 25 cm.

14. The arrangement as claimed in one of the preceding claims, characterized in that a liquid-manure pit (3) with a slatted floor (31) for accommodating the liquids collected in the grooves (15) is arranged at at least one head end (16) of the grooved floor (1).

15. The arrangement as claimed in one of the preceding claims, characterized in that a mucking system (200) with a slide (220) which can be moved in the longitudinal direction of the grooves (15) is arranged on the grooved floor (1).

16. The arrangement as claimed in claim 15, characterized in that the slide (220) has tine-like extensions (221) which correspond to the groove arrangement and engage in the grooves (15) during operation.

17. The arrangement as claimed in one of the preceding claims, characterized in that the grooved floor (1) is formed from precast concrete slabs (11).

18. The arrangement as claimed in claim 17, characterized in that the precast concrete slabs (11) are designed as a replacement covering for conventional semi-liquid-manure pits with a slatted base, the grooves (15) containing through-passage holes (135) to the underside of the slabs as a drain for the liquid manure.

19. A precast concrete slab for constructing an arrangement as claimed in one of claims 1 to 18, characterized in that the precast concrete slab (11) corresponds to the floor width and has fitting elements (17, 18) in the longitudinal direction for the accurately fitting alignment of the slabs which are to be joined to one another.

20. The precast concrete slab as claimed in claim 19, characterized in that the fitting elements (17, 18) comprise protrusions (17) arranged on one end side of the slab and associated sockets (18) arranged on the other end side of the slab.

21. The precast concrete slab as claimed in either of claims 7 and 8, characterized in that essentially equally spaced-apart grooves (25) are provided over the floor width, a relatively wide central concrete part (19) being provided in the center and in each case one side strip (20) without an elastic covering (14, 24) being provided at the border.

22. A method of keeping livestock in an arrangement as claimed in one of the preceding claims, characterized in that an organic or mineral binder is scattered in the cubicle barn and, during mucking, bound solid manure and liquid manure are separated.

23. The method of keeping livestock as claimed in claim 14, characterized in that straw, shredded straw, wood shavings and/or sand are scattered in the cubicle barn as binders. plastic or metal, preferably steel.

27. The arrangement as claimed in claim 25, characterized in that, on its top side, the concrete slab (11) has accommodating channels (12) for the U-profiles (13).

28. The arrangement as claimed in claim 25, characterized in that up to ⅓ to ⅚ of the leg height of the U-profile (13) penetrates into the concrete slab (11) and the rest of the vertical extent between adjacent U-profiles (13) is filled with the covering (14).

29. The arrangement as claimed in claim 25, characterized in that the U-profile (13) has legs (132) with a height of from 2-20 cm, preferably approximately 10 cm, and, with the base (131), defines a groove width of from 3-4 cm, preferably 3.5 cm.

30. The arrangement as claimed in claim 25, characterized in that the parallel U-profiles (13) are connected at their base (131) at the desired spacing by a connecting element (134), preferably by means of flat iron bars welded therebeneath.

31. The arrangement as claimed in claim 24, characterized in that the grooves (15) are defined in full by the concrete of the concrete slab (11), the concrete slab (11), between adjacent grooves (15), having an accommodating depression (120) which extends more or less as far as the grooves (15) and is filled with the elastic and anti-slip covering (14) to form a planar surface.

32. The arrangement as claimed in claim 31, characterized in that the accommodating depression (120) of the concrete slab (11) between adjacent grooves (15) has a rectangular or hemiellipsoidal cross section in the cross-sectional direction in relation to the grooves (15).

33. The arrangement as claimed in claim 31, characterized in that a concrete border region (130) for the grooves (15) on the surface (10) on both sides of the groove (15), which is approximately 3 cm wide, has a width of in each case 2 cm and the sunken formation of the concrete surface (accommodating depression (120)) is approximately 2 cm on average.

34. The arrangement as claimed in claim 33, characterized in that the concrete groove-border region (130) is reinforced by a reinforcing element, preferably a reinforcing steel member (26).

35. The arrangement as claimed in claim 24, characterized in that the elastic covering (14) is formed from a bituminous substance, preferably asphalt, or an elastomer.

36. The arrangement as claimed in claim 24, characterized in that the grooves (15) are arranged parallel in the longitudinal direction of the grooved floor (1) and have a center-to-center spacing from one another of 16-50 cm, preferably 25 cm.

37. The arrangement as claimed in claim 24, characterized in that a liquid-manure pit (3) with a slatted floor (31) for accommodating the liquids collected in the grooves (15) is arranged at at least one head end (16) of the grooved floor (1).

38. The arrangement as claimed in claim 24, characterized in that a mucking system (200) with a slide (220) which can be moved in the longitudinal direction of the grooves (15) is arranged on the grooved floor (1).

39. The arrangement as claimed in claim 18, characterized in that the slide (220) has tine-like extensions (221) which correspond to the groove arrangement and engage in the grooves (15) during operation.

40. The arrangement as claimed in claim 24, characterized in that the grooved floor (1) is formed from precast concrete slabs (11).

41. The arrangement as claimed in claim 40, characterized in that the precast concrete slabs (11) are designed as a replacement covering for conventional semi-liquid-manure pits with a slatted base, the grooves (15) containing through-passage holes (135) to the underside of the slabs as a drain for the liquid manure.

42. A precast concrete slab for constructing an arrangement as claimed in claim 24, characterized in that the precast concrete slab (11) corresponds to the floor width and has fitting elements (17, 18) in the longitudinal direction for the accurately fitting alignment of the slabs which are to be joined to one another.

43. The precast concrete slab as claimed in claim 42, characterized in that the fitting elements (17, 18) comprise protrusions (17) arranged on one end side of the slab and associated sockets (18) arranged on the other end side of the slab.

44. The precast concrete slab as claimed in claim 30, characterized in that essentially equally spaced-apart grooves (25) are provided over the floor width, a relatively wide central concrete part (19) being provided in the center and in each case one side strip (20) without an elastic covering (14, 24) being provided at the border.

45. A method of keeping livestock in an arrangement as claimed in claim 24, characterized in that an organic or mineral
